(19) United States
(12) Patent Application Publication
(10) Pub. No.: US 2004/0051303 A1
(43) Pub. Date: Mar. 18, 2004

(54) Multi-length flex connector

(76) Inventor: Alexander Lorenz, Winchester, MA (US)

Correspondence Address: Richard L. Sampson, Sampson & Associates, P.C., 50 Congress Street, Boston, MA, 02109, US

(21) Appl. No.: 10/461,989

(22) Filed: Jun. 13, 2003

Related U.S. Application Data
(60) Provisional application No. 60/388,640, filed on Jun. 14, 2002.

(51) Int. Cl. F16L 25/00

(52) U.S. Cl. 285/12; 285/256

(57) ABSTRACT

A plumbing connector assembly and method includes a mesh-reinforced composite flexible hose, the hose having a threaded fastener disposed on one end thereof, and a metallic tube having a length within a range of approximately 10 to 20 inches. The tube has an outer diameter which is substantially consistent along the length thereof, and is field-cuttable at any of a plurality of locations along the length thereof to provide the connector assembly with one of a plurality of user-selectable lengths. The outer diameter is sized to fastenably engage a stop valve using a compression fitting at any of the plurality of locations along the length thereof. The tube has a nipple disposed at an end thereof, and the hose is crimped onto the nipple.

### RELATED APPLICATION

This application claims the benefit of U.S. Provisional Application Ser. No. 60/388,640, entitled Flexible, Length Adjustable Water Connector For Hookup Of Faucets, Toilet Tanks And Other Devices And Appliances To Water Supply Valves, filed Jun. 14, 2002.

### BACKGROUND

1. Technical Field

This invention relates to plumbing equipment and, more particularly, to fittings for use with water connectors, such as faucets and toilets.

2. Background Information

Throughout this application, various publications, patents and published patent applications are referred to by an identifying citation. The disclosures of the publications, patents and published patent applications referenced in this application are hereby incorporated by reference into the present disclosure.

In the past, sinks, wash basins, toilet tanks or other appliances were installed, by using a pipe such as a copper pipe which was suitably bent for attachment to the end of a water distribution pipe and the water supply intake of the appliance. The plumber or other installer had to make precise measurements, cut the copper pipe accordingly, shape it and finally connect it by welding. Such tasks were burdensome, cumbersome, and slow and not readily adaptable for do-it-yourself amateurs and most homeowners.

Rigid supply tube assemblies have been used for many years in the plumbing market, which may eliminate the need for welding. These assemblies have been installed for many years by carefully measuring the distance between a stop valve of a water distribution pipe, and the installed fixture/appliance, cutting a rigid copper tube to size using a metal tube cutter, bending the tube as necessary to properly align the ends with the fixture and stop valve, and then fastening the tube at both ends using compression fittings. The complexity of this process generally meant that the task was unsuited to homeowners and other laypeople, but rather, required the services of a professional plumber. Moreover, there is also a risk of kinking these tubes while bending them too far, which would render the tubes unusable.

Flexible pipes have also been used to connect a sanitary appliance to a distribution network. A common type of flexible pipe included a copper tubular structure having corrugated walls which enabled the pipe to be manually bent to the position of the fluid intake on the appliance as well as to the end of the distribution pipe. However, in order to be flexible, this type of tube had a thin fragile metallic wall, which often cracked upon repetitive bending or flexing. Such cracks caused water leaks from the pipe.

The body of the corrugated supply assembly allowed some flexibility, but still many homeowners had trouble doing-it-themselves. If the corrugated supply assembly is bent into one position, then bent again to correct a mistake in the alignment, it work-hardens the tubing. Usually, two or three bends work-hardens the tubing to its failure point. The supply tube assembly often splits and forms a hole between one or more of its corrugations causing water leaks.

Moreover, the connections of appliances supplied with water using these conventional metal pipes have the drawback of transmitting vibrations from the sink or other appliance, when the faucet is turned on, to the supply pipe. The use of a faucet of poor quality on the appliance produces vibrations which can be transmitted to the entire house, or to adjacent apartments and possibly even through the whole building.

Ostensibly to address the foregoing drawbacks, flexible polymeric hoses were introduced. These hoses generally consisted of a flexible polymer hose (e.g., Polyvinyl Chloride (PVC) with two attached fittings. A fitting at one end of the hose is typically attached to the faucet base by means of a nut using a washer, o-ring, or plastic head. The other end of the hose is attached to a supply valve or supply pipe using a washer or o-ring.

In more recent years, home centers, hardware stores and plumbing suppliers began carrying flexible, metallic mesh-reinforced hoses having threaded connectors at the ends for threadably engaging both the fixture and the stop valve. As optional variations, these hoses may include use of a cylindrical brass nipple at one end for coupling to the stop valve using a conventional compression coupling. The pre-configured connectors are typically installed to the mesh-reinforced hose by concentrically engaging the hose ends with a barbed portion of a hard metal (e.g., brass) connector, placing a cylindrical ferrule concentrically thereover, and then crimping the ferrule to hold the assembly in place. An example of a flexible connector assembly of this general type is disclosed in U.S. Pat. No. 5,024,419, entitled Faucet Connector Assembly, which issued on Jun. 18, 1991.

The flexibility of these mesh-reinforced hoses, combined with the pre-configured connectors at both ends, advantageously enabled homeowners and others to securely couple fixtures to their water supplies themselves, without professional assistance.

These flexible mesh-reinforced hoses have proven to be quite popular, not only for homeowners, but also for professional plumbers who have realized substantial labor savings in many installations. A drawback of these assemblies, however, is that due to their pre-configured end connectors, their length is not adjustable. So, while suppliers and others in the supply chain could in the past simply stock a single length of copper tube to be cut as desired in the field, they now find themselves stocking several sizes of flexible hose assemblies to satisfy various installation requirements. For example, many distributors, retailers, and even plumbers themselves, have found it desirable to stock flexible hose assemblies in a range of lengths, such as of 6″, 9″, 12″, 16″, 20″, 30″ and more, to accommodate various installation configurations.

Relative to a single stock item, stocking of multiple sizes requires additional warehouse and vehicle space, additional capital outlays to purchase items in each size, and generally adds complexity to inventory operations, which tend to disadvantageously increase costs overall.

An additional drawback associated with these flexible mesh-reinforced hoses pertains to exposed or semi-exposed installations, such as pedestal sink installations. In these applications, the hoses are highly visible, and any excess length in the hoses generally causes them to hang loosely or coil randomly, to generate a messy or tangled appearance that is often found objectionable by property owners.

Thus, a need exists for a flexible faucet tube assembly that is capable of being inventoried and sold in a single size, while being conveniently shortened as required in the field.

### SUMMARY

In one aspect of the invention, a faucet connector assembly includes a mesh reinforced flexible hose having a threaded fastener crimped onto one end thereof, and a copper tube having a length within a range of approximately 10 to 20 inches. The tube has an outer diameter which is substantially consistent along the length thereof, and is field-cuttable at any of a plurality of locations along the length thereof to provide the connector assembly with one of a plurality of user-selectable lengths. The outer diameter is sized to fastenably engage a stop valve using a compression fitting at any of the plurality of locations along the length thereof, and is approximately 0.3 inches. The tube has a wall thickness along the length thereof within a range of approximately 0.02 to 0.03 inches to facilitate bending by hand. The copper tube has an integral nipple formed at an end thereof, to form a one-piece tube/nipple assembly, with the hose being crimped at an other end thereof onto the integral nipple. In another aspect of the invention, a plumbing connector assembly includes a mesh-reinforced composite flexible hose, the hose having a threaded fastener disposed on one end thereof, and a metallic tube having a length within a range of approximately 10 to 20 inches. The tube has an outer diameter which is substantially consistent along the length thereof, the tube being field-cuttable at any of a plurality of locations along the length thereof to provide the connector assembly with one of a plurality of user-selectable lengths. The outer diameter is sized to fastenably engage a stop valve using a compression fitting at any of the plurality of locations along the length thereof. The tube has a nipple disposed at an end thereof, and the hose is crimped onto the nipple.

In another aspect of the invention, a method of fabricating a faucet connector assembly includes providing a mesh-reinforced flexible hose, crimping one end of the hose to a threaded faucet fastener, and providing a copper tube having a length within a range of approximately 10 to 20 inches that has an outer diameter which is substantially consistent along the length thereof, which is field-cuttable at any of a plurality of locations along the length thereof to provide the connector assembly with one of a plurality of user-selectable lengths, and which has an outer diameter sized to fastenably engage a stop valve using a compression fitting at any of the plurality of locations along the length thereof, the outer diameter being approximately 0.3 inches, and the tube having a wall thickness along the length thereof within a range of approximately 0.02 to 0.03 inches so that it is bendable by hand. The method further includes forming an integral nipple into an end of the copper tube, to form a one-piece tube/nipple assembly, and crimping an other end of the hose onto the integral nipple.

In a still further aspect of the invention, a method of fabricating a plumbing connector includes selecting a mesh-reinforced composite flexible hose, fastening a threaded faucet fastener to one end of the hose, and selecting a tube having an outer diameter which is substantially consistent along the length thereof, is field-cuttable at any of a plurality of locations along the length thereof to provide the connector assembly with one of a plurality of user-selectable lengths, has an outer diameter sized to fastenably engage a stop valve using a compression fitting at any of the plurality of locations along the length thereof. The method further includes cutting the metallic tube to a length within a range of approximately 10 to 20 inches, plus length of nipple, disposing a nipple at one end of the tube; and crimping the hose at an other end thereof onto the nipple.

### BRIEF DESCRIPTION OF THE DRAWINGS

The above and other features and advantages of this invention will be more readily apparent from a reading of the following detailed description of various aspects of the invention taken in conjunction with the accompanying drawings, in which:

FIG. 1 is an elevational view of an embodiment of the present invention;

FIG. 2 is a view similar to that of FIG. 1, on a reduced scale, engaged at one end thereof with a conventional water supply valve;

FIG. 3 is a perspective, partially exploded view, partially broken-away view, on an enlarged scale, of the engagement of the embodiment of FIG. 2 with the water supply valve;

FIG. 4 is a cross-sectional view of a portion of the embodiment of FIGS. 1-3;

FIGS. 5 and 6 are schematic elevational views of portions of alternate embodiments of the present invention;

FIGS. 7 and 9 are elevational views of portions of the embodiment of FIGS. 1-4;

FIG. 8 is a schematic elevational view of a portion of a fabrication process used to fabricate portions of the embodiments of FIGS. 1-4; and

FIGS. 10-12 are views similar to that of FIGS. 5 and 6, of still further embodiments of the present invention.

### DETAILED DESCRIPTION

In the following detailed description, reference is made to the accompanying drawings that form a part hereof, and in which is shown by way of illustration, specific embodiments in which the invention may be practiced. These embodiments are described in sufficient detail to enable those skilled in the art to practice the invention, and it is to be understood that other embodiments may be utilized. It is also to be understood that structural, procedural and system changes may be made without departing from the spirit and scope of the present invention. The following detailed description is, therefore, not to be taken in a limiting sense, and the scope of the present invention is defined by the appended claims and their equivalents. For clarity of exposition, like features shown in the accompanying drawings shall be indicated with like reference numerals and similar features as shown in alternate embodiments in the drawings shall be indicated with similar reference numerals.

Embodiments of the present invention includes a flexible water supply tube for plumbing applications, which may be conveniently cut to one of multiple lengths. As shown in the attached figures, these embodiments include a flexible mesh-reinforced rubber water supply tube, having a threaded connecter at one end for coupling to a plumbing fixture such as a faucet. The other end of the device includes an integral, rigid or semi-rigid metallic (e.g., copper) tube, having a predetermined diameter (e.g., ⅜″ OD) for fastening to a stop valve using a conventional compression fitting. The copper tube may be conveniently cut to a desired length, in a manner familiar to those skilled in the art of installing plumbing fixtures, prior to being fastened to the stop valve.

These embodiments advantageously provide a single-size assembly adapted to provide convenient and secure installation of faucets and the like, while advantageously permitting it to be cut to size in the field. This enables those in the product supply chain, such as hardware stores, home centers, plumbing supply houses, and plumbers, to reduce inventory by stocking a single item instead of a range of otherwise identical items in a range of sizes, for reduced inventory complexity and costs. Moreover, in many installations, such as pedestal sinks, the flexible mesh portion can be hidden behind the basin, leaving the copper tube portion exposed for a professional and esthetically pleasing appearance. The use of copper to fabricate the tube portion also advantageously permits some degree of mechanical flexibility, while being easily finished in chrome, gold, or other decorative colors to further enhance the esthetics of the installation.

Where used in this disclosure, the term “axial” when used in connection with an element described herein, shall refer to a direction relative to the element, which is substantially parallel to its central, longitudinal axis, i.e. parallel to the direction of water flow therethrough. Similarly, the term “transverse” shall refer to a direction substantially orthogonal to the axial direction. The terms “transverse cross-section” or “transverse circumference” shall refer to a cross-section or circumference, respectively, taken along a plane oriented substantially orthogonally to the axial direction.

Referring now to the figures, embodiments of the present invention will be described in detail.

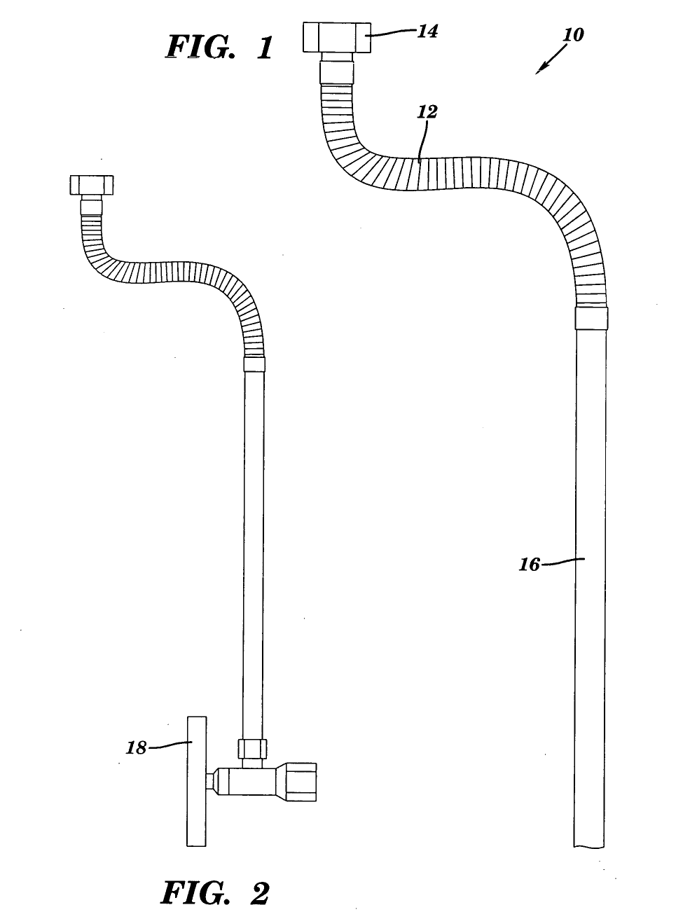

As shown in FIG. 1, flexible water supply assembly 10 of the present invention includes a flexible mesh (e.g., wire-mesh or polymer fiber-mesh) reinforced rubber water supply hose 12, having a conventional threaded connector 14 at an end thereof. Connector 14 is sized and shaped for coupling to an inlet of a conventional plumbing fixture such as a sink faucet or toilet. The other end of assembly 10 includes an integral, metallic tube 16, which, in particular embodiments, is fabricated from copper or other relatively soft, malleable (i.e., semi-rigid) metal.

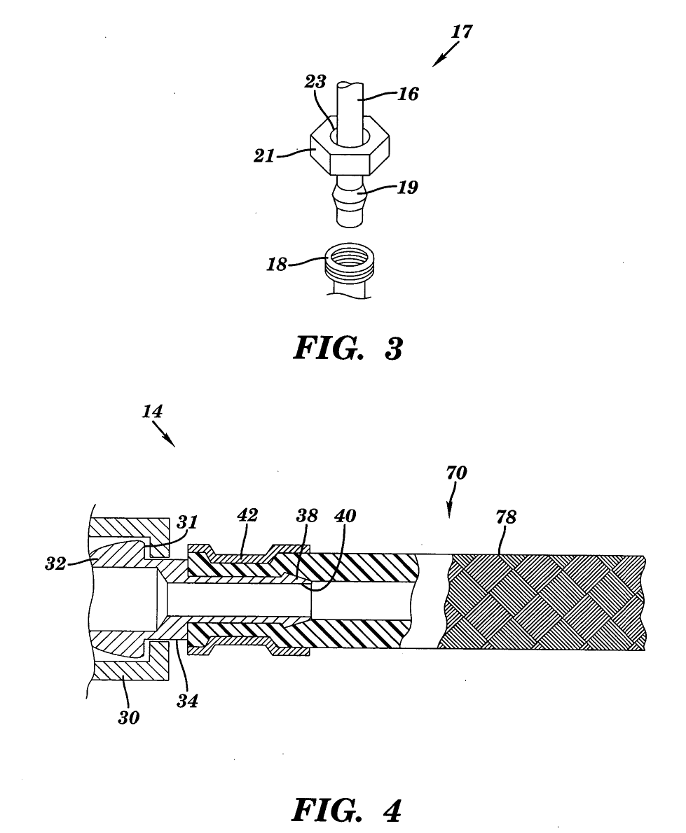

As shown in FIGS. 2 and 3, tube 16 is provided with an outer diameter (OD) sized for being received within a conventional stop valve 18 using a conventional compression fitting 17. As best shown in FIG. 3, fitting 17 includes a compression ring 19, and an internally threaded compression nut 21 with a collar 23 that is positioned against, engages, and compresses the compression ring 19 about tubing 16 when nut 21 is threadably engaged with the threads of stop valve 18. Tightening of the nut 21 onto valve 18 serves to press the ring 19 snugly between the tube 16 and the wall of the valve 18, to form a water-tight seal.

As it is fabricated from a malleable metal commonly used in plumbing applications (e.g., copper), tube 16, prior to being fastened to stop valve 18, tube 16 may be easily cut to a desired length using a tube cutter of the type commonly used in plumbing applications. The flexible hose 12 provides sufficient flexibility to enable the installer to easily fasten connector 14 to the fixture (e.g., faucet).

Turning now to FIG. 4, threaded connector 14 includes a compression nut 30 captured by a shoulder 31 of head 32 of hollow nipple 34. At the opposite end of nipple 34 from head 32, is a foot 36, configured with at least one frustoconical hose barb 38, sized to engage and fit snugly into an end of the mesh-reinforced hose 12. The nipple 34 has an elongated inlet passageway 40, that extends along the axis thereof. A tubular crimping ferrule 42 is concentrically superposed with both the nipple 34 and hose 12, and crimped radially inwardly to securely fasten connector 14 to the composite hose 12.

In exemplary embodiments, the OD of tube 16 is ⅜″, to accommodate most conventional stop valves 18. Hose 12 is typically in the range of approximately 6-12 inches in length, while tube 16 is in the range of approximately 10-20 inches in length. Tube 16 is shown and described in greater detail with respect to FIG. 6, below.

An aspect of the present invention was the recognition of difficulties associated with fastening tube 16 to hose 12 in a manner that provides a secure connection in a manner that is easily and inexpensively manufacturable. It was realized that conventional crimping techniques, such as described hereinabove with respect to nipple 34 of FIG. 4, satisfy some of these criteria by providing a secure and relatively easy to manufacture connection. However, the crimping forces inherent in this approach require the use of a relatively robust nipple, to resist the radially compressive forces applied during crimping. The nipple 34 (FIG. 4), has been fabricated from brass to provide this required structural integrity.

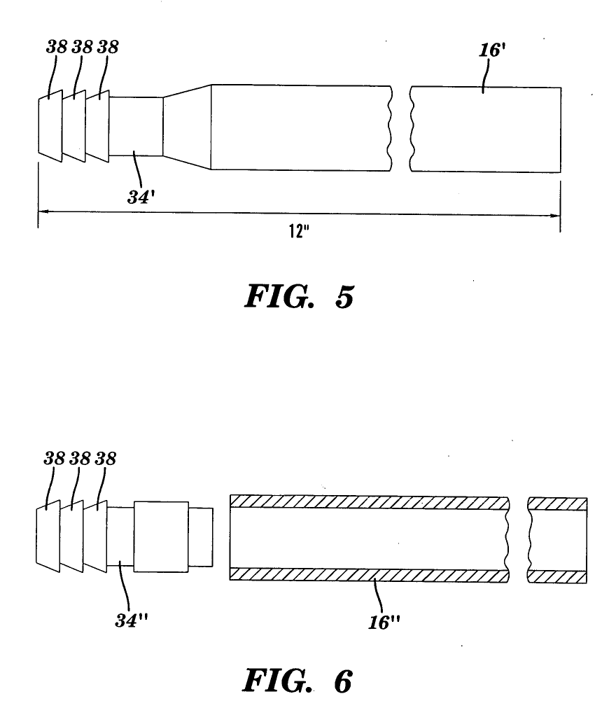

Turning now to FIG. 5, one technique that may be used in connection with the present invention is to fabricate a brass nipple 34′ similar to that shown in FIG. 4, which is extended axially to form an integral brass tube 16′. Being fabricated from brass, this approach provides the requisite structural integrity for being crimped to hose 12. The one-piece construction facilitates manufacturability. While this approach may be satisfactory in some applications, it tends to be relatively costly to manufacture, and since it is fabricated from relatively hard brass, tube 16′ may be difficult to cut in the field. Brass is also relatively expensive, and the resulting tube 16′ is relatively rigid, which makes it difficult, if not practically impossible, for a user to bend in the field if desired.

Referring now to FIG. 6, another approach is shown, that overcomes a drawback of the embodiment of FIG. 5. In this embodiment, a nipple 34″ is fabricated from brass, to provide the above-described structural integrity sufficient for the crimping process. A discrete tube 16″, fabricated from a relatively malleable metallic material, such as copper, is sized and shaped to interfit with an end of the nipple 34″. These components may then be securely fastened to one another in any convenient manner, such as by soldering or brazing. Advantages of this approach include the provision of a relatively robust nipple to facilitate the crimping process, while also providing a metal tube 16″ that may be easily cut to length in the field, and may itself provide some degree of flexibility which may be desirable in some applications. This embodiment may prove to be adequate in many applications. However, fastening the tube 16″ to nipple 34″ is an extra manufacturing step that may increase the cost of then final product, both because of the added soldering or brazing step, and because the engagable portions of the nipple and tube themselves must be fabricated to relatively tight geometric tolerances in order to facilitate their mutual, leak-free engagement.

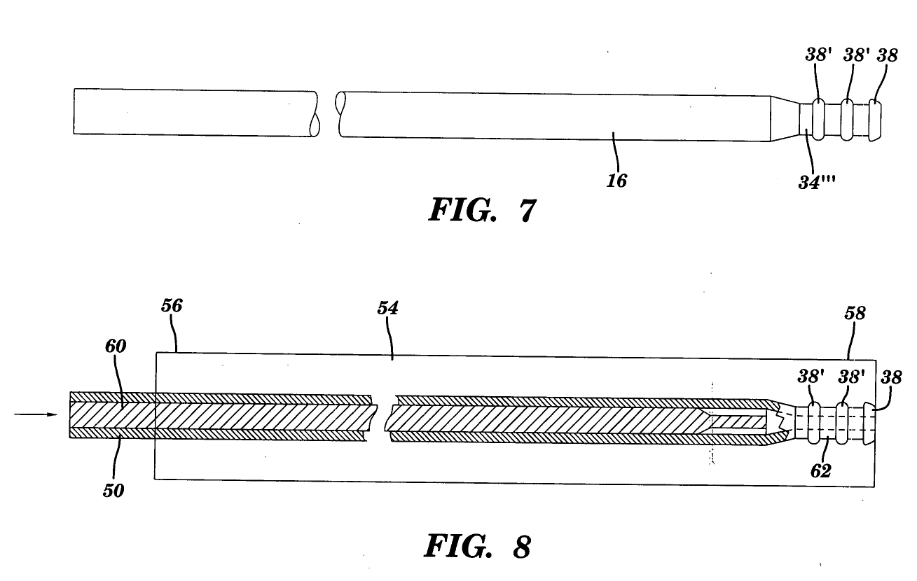

Turning now to FIG. 7, an alternative embodiment is shown that has been found to overcome the aforementioned drawbacks. This embodiment includes tube 16 fabricated from conventional malleable metal (e.g., copper) tubing sized for typical plumbing use (e.g., ⅜″ OD), which is provided with an integral nipple 34′″. This one-piece nipple/tube construction provides the benefits of a tube 16 that is easy to cut (and in some optional embodiments, bendable by hand, if desired) in the field, a nipple 34′″ that can be securely crimped to a hose 12, while also providing the benefits of being relatively inexpensive to manufacture due its one-piece construction and use of copper (rather than brass). The one-piece aspect of this embodiment also advantageously nominally eliminates any chance of leaks at the junction of tube 16 and nipple 34′″, and provides an aesthetically pleasing finished appearance.

The successful production and use of this embodiment was surprising, due to the common understanding that commercially available copper tubing of the size (e.g., ⅜″ OD) used for plumbing supply lines has insufficient structural integrity to withstand the radially compressive crimping forces described hereinabove. This success was achieved by use of a metal forming technique that sized and shaped nipple 34′″ in a manner that carefully balanced the competing characteristics of tube rigidity (i.e., for a successful crimp) and flexibility (for convenient cutting and optionally, hand-bending in the field).

In particular embodiments, a successful unitary copper tube/nipple combination is fabricated by forming nipple 34′″ onto a commercially available copper tube using the technique described hereinbelow with respect to Table 1 and FIG. 8. Referring now to Table 1 and FIG. 8, a mold half 54 is provided 55, which has a generally semi-cylindrical mold cavity in the size and shape of a longitudinal cross-section of the tube/nipple combination of FIG. 7, including a proximal end 56 and a distal end 58. Distal end 58 has a generally smaller diameter than proximal end 56 as shown. A piece of conventional copper tube stock 50 sized and shaped for slidable receipt within proximal end 56, is inserted 57 therein, and moved axially 59 towards distal end 58 until further axial progress is inhibited by the reduced diameter of the distal nipple end, such as shown in FIG. 8. A rod 60, having an outer diameter sized and shaped to be slidably received within tube stock 50, and having a reduced diameter at a distal end 62 thereof, is inserted 65 into the tube stock. The rod effectively prevents collapse of the tube stock during further processing, as will be discussed hereinbelow.

A second mold half (not shown), having a mold cavity substantially identical to that of the first mold half, is mated 61 with the first mold half 54 in a conventional manner to form a complete mold cavity of cylindrical transverse cross-section. Thereafter, the tube stock 50, and rod 60, are axially pressed 63, in unison, towards distal end 58. This axially pressing 63 may be effected using any conventional pressing means, such as by use of a hydraulic or pneumatic press of sufficient capacity to plastically deform the tube 50 as described herein. Moreover, such pressing may be effected with or without application of heat, i.e., in either a cold-forming or hot-forming operation.

Pressing 63 thus serves to plastically deform the tube stock 50 into a reduced diameter at distal end 58. This axially compressive movement of the tube and rod is continued until the tube and rod reach the terminal end of the mold, such as shown in phantom in FIG. 8, upon which continued compressive movement serves to push the copper tube material radially outward into bead recesses to form a bead 38 and/or bead(s) 38′. As shown, beads 38 is frusto-conical as described hereinabove. Alternatively, beads 38′ may be provided, having an annular or donut shaped configuration as shown, which are generally formed more easily than frusto-conical barbs 38 by hot or cold forming.

TABLE 1

| | |
|---|---|
| 55 | providing a mold half 54 having a distal nipple end |
| | of reduced diameter |
| 57 | inserting a copper tube stock 50 into the mold half 54 |
| 59 | axially moving tube stock towards distal end 58 until further axial |
| | progress is inhibited by the reduced diameter of the distal |
| | nipple end |
| 65 | inserting a rod 60 into tube stock 50 |
| 61 | mating a second mold half to the first mold half |
| 63 | axially pressing the tube stock and rod towards distal end 58 to |
| | plastically deform the tube 50 to form a nipple |

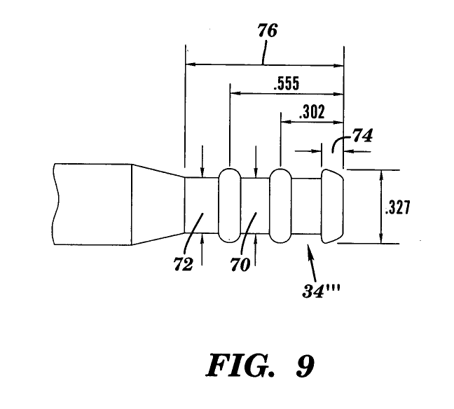

Turning now to FIG. 9, in an exemplary embodiment, tube 50 had an OD of ⅜ (0.375) inches, and a wall thickness of 0.028-0.032 inches. Nipple 34′″ was formed to have an OD 70 of 0.270 inches, a bead OD 72 of 0.340 inches, and an axial bead dimension 74 of 0.093 inches. A frusto-conical bead 38 was disposed at the distal 58, with two beads 38′ were respectively centered at about 0.302 and 0.555 inches inwardly therefrom. Nipple 34′″ had a cylindrical length 76 of about 0.764 inches, which then faired radially outwardly to the tube diameter of ⅜ inches.

When appropriately sized, this unitary copper tube 16 and nipple 34′″ advantageously provides a cost-effective construction having sufficient strength/rigidity to form a water-tight crimped coupling with flexible tube 12, while providing tube 16 with sufficient flexibility to be bent in the field as desired for specific installations.

Although exemplary dimensions are shown and described herein, the skilled artisan will understand that these dimensions may be varied, and a greater or lesser number of beads may be used, without departing from the spirit and scope of the present invention.

Although tube 16 and nipple 34′″ are described herein as being fabricated by a forming operation, the skilled artisan will recognize that any number of convenient techniques may be utilized, including molding, machining using a lathe or other device, or other types of metal forming, without departing from the spirit and scope of the present invention.

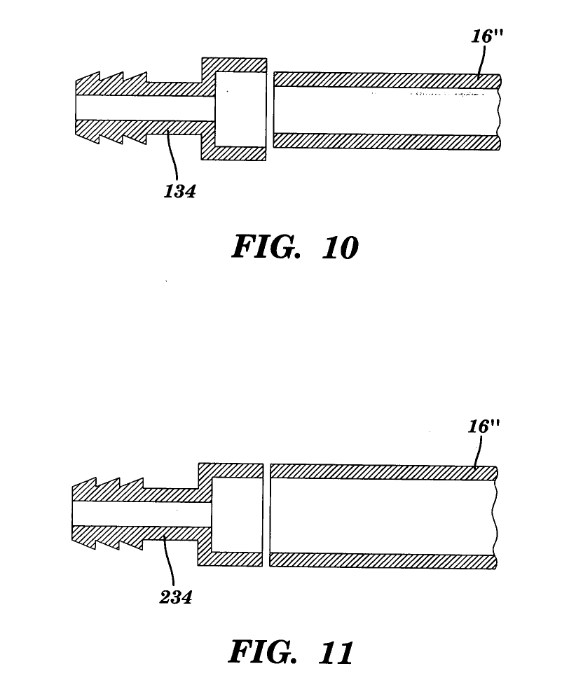

Turning now to FIGS. 10-12, further variations of the two-piece tube/nipple embodiment of FIG. 6 are shown. The embodiment of FIGS. 10 is similar to that of FIG. 6, though having a nipple 134 that receivably engages tube 16″ therein. The assembly of FIG. 11 utilizes a nipple 234 having a tube engagement portion of nominally the same diameter as tube 16″, to form a butting seal therewith, e.g., by welding or brazing. The nipple 334 of FIG. 12 is configured for fitting within an end of tube 16, and being crimped into place, upon application of a radially compressive force such as described hereinabove.

In the preceding specification, the invention has been described with reference to specific exemplary embodiments thereof. It will be evident that various modifications and changes may be made thereunto without departing from the broader spirit and scope of the invention as set forth in the claims that follow. The specification and drawings are accordingly to be regarded in an illustrative rather than restrictive sense.

Having thus described the invention, what is claimed is:

1. A faucet connector assembly comprising:
a mesh reinforced flexible hose;
the hose having a threaded fastener crimped onto one end thereof;
a copper tube having a length within a range of approximately 10 to 20 inches;
the tube having an outer diameter which is substantially consistent along the length thereof;
the tube being field-cuttable at any of a plurality of locations along the length thereof to provide the connector assembly with one of a plurality of user-selectable lengths;
the outer diameter being sized to fastenably engage a stop valve using a compression fitting at any of the plurality of locations along the length thereof;
the outer diameter being approximately 0.3 inches;
the tube having a wall thickness along the length thereof within a range of approximately 0.02 to 0.03 inches so that it is bendable by hand;
the copper tube having an integral nipple formed at an end thereof, to form a one-piece tube/nipple assembly;
the hose being crimped at an other end thereof onto the integral nipple.

2. A plumbing connector assembly comprising:
a mesh-reinforced composite flexible hose;
the hose having a threaded fastener disposed on one end thereof;
a metallic tube having a length within a range of approximately 10 to 20 inches;
the tube having an outer diameter which is substantially consistent along the length thereof;
the tube being field-cuttable at any of a plurality of locations along the length thereof to provide the connector assembly with one of a plurality of user-selectable lengths;
the outer diameter being sized to fastenably engage a stop valve using a compression fitting at any of the plurality of locations along the length thereof;
the tube having a nipple disposed at an end thereof;
the hose being crimped at an other end thereof onto the nipple.

3. The connector of claim 2, wherein the outer diameter is approximately 0.3 inches.

4. The connector of claim 2, wherein the wall thickness is within a range of approximately 0.02 to 0.03 inches.

5. The connector of claim 4, wherein the wall thickness is within a range of approximately 0.028 to 0.032 inches.

6. The connector of claim 2, wherein the tube and nipple are fabricated from the same material.

7. The connector of claim 6, wherein the tube and nipple are fabricated from copper.

8. The connector of claim 7, wherein the tube and nipple are fabricated as one-piece.

9. The connector of claim 2, wherein the tube is soldered to the nipple.

10. The connector of claim 2, wherein the tube is brazed to the nipple.

11. The connector of claim 2, wherein the tube is fabricated from copper.

12. The connector of claim 11, wherein the nipple is fabricated from brass.

13. The connector of claim 1 1, wherein the nipple is fabricated from copper.

14. The connector of claim 2, wherein the mesh-reinforced hose is wire-mesh reinforced.

15. The connector of claim 2, wherein the mesh-reinforced hose is polymer-fiber mesh reinforced.

16. A method of fabricating a faucet connector assembly comprising:
(a) providing a mesh-reinforced flexible hose;
(b) crimping one end of the hose to a threaded fastener;
(c) providing a copper tube having a length within a range of approximately 10 to 20 inches, that has an outer diameter which is substantially consistent along the length thereof, which is field-cuttable at any of a plurality of locations along the length thereof to provide the connector assembly with one of a plurality of user-selectable lengths, and which has an outer diameter sized to fastenably engage a stop valve using a compression fitting at any of the plurality of locations along the length thereof, the outer diameter being approximately 0.3 inches, and the tube having a wall thickness along the length thereof within a range of approximately 0.02 to 0.03 inches so that it is bendable by hand;
(d) forming an integral nipple into an end of the copper tube, to form a one-piece tube/nipple assembly; and
(e) crimping an other end of the hose onto the integral nipple.

17. A method of connecting a faucet to a water supply, the method comprising:
(a) selecting the faucet connector of claim 1;
(b) field cutting the copper tube at any one of a plurality of locations along the length thereof to provide the connector with a desired length;
(c) bending the tube as desired; and
(d) inserting the copper tube into a stop valve using a compression fitting at the one location along the length thereof.

18. A method of fabricating a plumbing connector, the method comprising:
(a) selecting a mesh-reinforced composite flexible hose;
(b) fastening a threaded fastener to one end of the hose;
(c) selecting a tube having an outer diameter which is substantially consistent along the length thereof, is field-cuttable at any of a plurality of locations along the length thereof to provide the connector assembly with one of a plurality of user-selectable lengths, has an outer diameter sized to fastenably engage a stop valve using a compression fitting at any of the plurality of locations along the length thereof;
(d) cutting the metallic tube to a length within a range of approximately 10 to 20 inches, plus length of nipple added in (e);
(e) disposing a nipple at one end of the tube; and
(f) crimping the hose at an other end thereof onto the nipple.

19. The method of claim 18, wherein the outer diameter is approximately 0.3 inches.

20. The method of claim 18, wherein the wall thickness is within a range of approximately 0.02 to 0.03 inches.

21. The method of claim 20, wherein the wall thickness is within a range of approximately 0.028 to 0.032 inches.

22. The method of claim 18, comprising fabricating the nipple from the same material as the tube.

23. The method of claim 22, comprising fabricating the nipple from copper.

24. The method of claim 23, comprising fabricating the nipple as one piece with the tube.

25. The method of claim 24, wherein said disposing (e) comprises:
(g) providing a mold half 54 having a proximal end, and a distal end, the distal end having a reduced-diameter nipple-molding configuration;
(h) inserting copper tube stock into the proximal end;
(i) axially moving the tube stock towards the distal end until further axial progress is inhibited by the reduced diameter of the distal nipple end;
(j) inserting a rod into the tube stock;
(k) mating a second mold half to the first mold half; and
(l) axially pressing the tube stock and rod towards the distal end with sufficient force to plastically deform the tube to form a nipple therein.

26. The method of claim 18, comprising welding the tube to the nipple.

27. The method of claim 18, comprising brazing the tube to the nipple.

28. The method of claim 18, wherein the tube is fabricated from copper.

29. The method of claim 28, wherein the nipple is fabricated from brass.

30. The method of claim 28, comprising fabricating the nipple from copper.

31. The method of claim 18, wherein the mesh-reinforced hose is wire-mesh reinforced.

32. The method of claim 18, wherein the mesh-reinforced hose is polymer-fiber mesh reinforced.

33. The connector of claim 3, wherein the outer diameter is approximately ⅜ inch.
